(19) United States
(12) Patent Application Publication
(10) Pub. No.: US 2016/0147300 A1
(43) Pub. Date: May 26, 2016

(54) Supporting Activation of Function of Device

(71) Applicant: NOKIA TECHNOLOGIES OY, Espoo (FI)

(72) Inventors: Zhuoyuan LIAO, Beijing (CN); Lijun SHAO, Beijing (CN); Naichen CUI, Beijing (CN); Liang ZHAO, Beijing (CN)

(73) Assignee: Nokia Technologies Oy, Espoo (FI)

(21) Appl. No.: 14/899,744

(22) PCT Filed: Jun. 28, 2013
(86) PCT No.: PCT/CN2013/078285

§ 371 Date: Dec. 18, 2015

(51) Int. Cl. G06F 3/01; G06K 9/78; G06K 9/00

(52) U.S. Cl. CPC G06F 3/013; G06K 9/00604; G06K 9/00362; G06K 9/78

(57) ABSTRACT

A first apparatus determines whether a user can be assumed to be looking at a device by evaluating data captured by at least one sensor, wherein the apparatus is physically unconnected to the device. In case it is determined that a user can be assumed to be looking at the device, the apparatus causes a transmission of a notification to a second apparatus via a wireless link, as a criterion for the second apparatus to activate a function of the device. The second apparatus monitors whether such a notification is received via a wireless link. The second apparatus activates a predetermined function of the device in case it is determined that such a notification has been received.

### FIELD OF THE DISCLOSURE

The invention relates to the field of activating functions of devices, and more specifically to supporting an automatic activation of a function of a device when needed by a user.

### BACKGROUND

Some devices support an automatic activation of a function in response to a certain event.

For instance, when a mobile phone receives an incoming call, it may automatically play a ringing tone and/or output a vibrating alarm in order to alert the user, and activate a display in order to provide a user with information about the call.

### SUMMARY OF SOME EMBODIMENTS OF THE INVENTION

According to a first aspect, a method is described which comprises determining, by an apparatus, whether a user can be assumed to be looking at a device by evaluating data captured by at least one sensor, wherein the apparatus is physically unconnected to the device; and causing, by the apparatus, a transmission of a notification to a second apparatus via a wireless link, in case it is determined that a user can be assumed to be looking at the device, as a criterion for the second apparatus to activate a function of the device.

According to a second aspect, a method is described which comprises monitoring, by an apparatus, whether a notification is received from a first device via a wireless link, the notification indicating that a user can be assumed to be looking at a second device, wherein the second device is physically unconnected to the first device; and activating, by the apparatus, a predetermined function of the second device in case it is determined that a notification has been received indicating that a user can be assumed to be looking at the second device.

Moreover an apparatus is described, which comprises means for realizing the actions of the method presented for the first aspect or means for realizing the actions of the method presented for the second aspect.

In either case, the means of the apparatus can be implemented in hardware and/or software. They may comprise for instance at least one processor for executing computer program code for realizing the required functions, at least one memory storing the program code, or both. Alternatively, they could comprise for instance circuitry that is designed to realize the required functions, for instance implemented in a chipset or a chip, like an integrated circuit. In general, the means may comprise for instance one or more processing means.

Moreover an apparatus is described, which comprises at least one processor and at least one memory including computer program code, the at least one memory and the computer program code configured to, with the at least one processor, cause at least one apparatus at least to perform the actions of the method presented for the first aspect or the actions of the method presented for the second aspect.

Any of the described apparatuses may be a module or a component for a device, for example a chip. Alternatively, any of the mentioned apparatuses may be a device. The apparatuses according to the first aspect may be in particular mobile devices, while the apparatuses according to the second aspect may be mobile devices or stationary devices.

Any of the described apparatuses may further comprise only the indicated components or one or more additional components.

In certain embodiments, the described methods are information providing methods, and the described apparatuses are information providing apparatuses.

In certain embodiments of the described methods, the methods are methods for supporting an activation of a function of a device. In certain embodiments of the described apparatuses, the apparatuses are apparatuses for supporting an activation of a function of a device.

Moreover a non-transitory computer readable storage medium is described, in which computer program code is stored. The computer program code causes at least one apparatus to perform the actions of the method presented for the first aspect or the actions of the method presented for the second aspect when executed by at least one processor.

The computer readable storage medium could be for example a disk or a memory or the like. The computer program code could be stored in the computer readable storage medium in the form of instructions encoding the computer-readable storage medium. The computer readable storage medium may be intended for taking part in the operation of a device, like an internal or external hard disk of a computer, or be intended for distribution of the program code, like an optical disc.

It is to be understood that also the respective computer program code by itself has to be considered an embodiment of the invention. The computer program code could also be distributed to several computer readable storage mediums.

Moreover, a system is described, which comprises any of the apparatuses presented for the first aspect and any of the apparatuses presented for the second aspect.

It is to be understood that the presentation of the invention in this section is merely by way of example and non-limiting.

Other features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not drawn to scale and that they are merely intended to conceptually illustrate the structures and procedures described herein.

### BRIEF DESCRIPTION OF THE FIGURES

FIG. 1 is a schematic block diagram of an example embodiment of an apparatus according to the first aspect;

FIG. 2 is a flow chart illustrating an example embodiment of a method according to the first aspect;

FIG. 3 is a schematic block diagram of an example embodiment of an apparatus according to the second aspect;

FIG. 4 is a flow chart illustrating an example embodiment of a method according to the second aspect;

FIG. 5 is a schematic illustrating of an example use case;

FIG. 6 is a schematic block diagram of an example embodiment of a system;

FIG. 7 is a flow chart illustrating an example operation at a first device of the system of FIG. 6;

FIG. 8 is a flow chart illustrating an example operation at a second device of the system of FIG. 6;

FIG. 9 is a schematic block diagram of an example embodiment of an apparatus;

FIG. 10 is a schematic block diagram of an example embodiment of an apparatus; and

FIG. 11 schematically illustrates example removable storage devices.

### DETAILED DESCRIPTION OF THE FIGURES

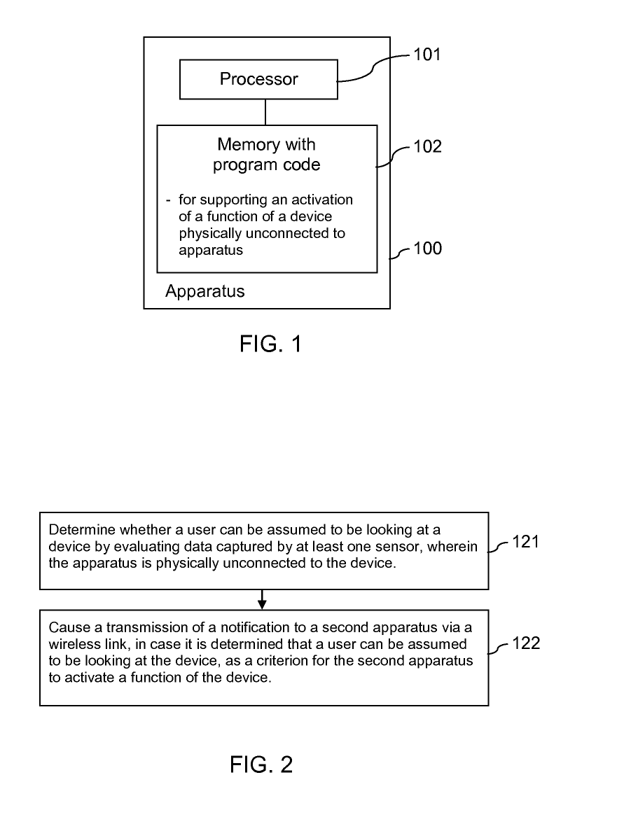

FIG. 1 is a schematic block diagram of an example embodiment of an apparatus according to the first aspect. Apparatus 100 comprises a processor 101 and, linked to processor 101, a memory 102. Memory 102 stores computer program code for supporting an activation of a function of a device. Processor 101 is configured to execute computer program code stored in memory 102 in order to cause an apparatus to perform desired actions. Memory 102 is thus an example embodiment of a non-transitory computer readable storage medium according to the first aspect, in which computer program code is stored.

Apparatus 100 could be for example any device such as a portable or a wearable device that may move along with the head of a user, like a pair of glasses or a cap or a device configured to be attached to a pair of glasses or to a cap, etc. Apparatus 100 could equally be a component, like a chip or circuitry on a chip for a device. Apparatus 100 could be for instance a module configured to be integrated into a pair of glasses, into a cap or into a device that can be attached to a pair of glasses or to a cap. Optionally, apparatus 100 could comprise various other components, like a camera, a communication interface configured to enable a wireless exchange of data with other apparatuses, a user interface, a further memory, a further processor, etc.

An operation of an apparatus will now be described with reference to the flow chart of FIG. 2. The operation is an example embodiment of a method according to the invention according to the first aspect. Processor 101 and the program code stored in memory 102 cause an apparatus to perform the operation when the program code is retrieved from memory 102 and executed by processor 101. The apparatus that is caused to perform the operation can be apparatus 100 or some other apparatus, for example but not necessarily a device comprising apparatus 100.

The apparatus determines whether a user can be assumed to be looking at a device by evaluating data captured by at least one sensor, wherein the apparatus is physically unconnected to the device. (action 121)

The apparatus furthermore causes a transmission of a notification to a second apparatus via a wireless link, in case it is determined that a user can be assumed to be looking at the device, as a criterion for the second apparatus to activate a function of the device. (action 122)

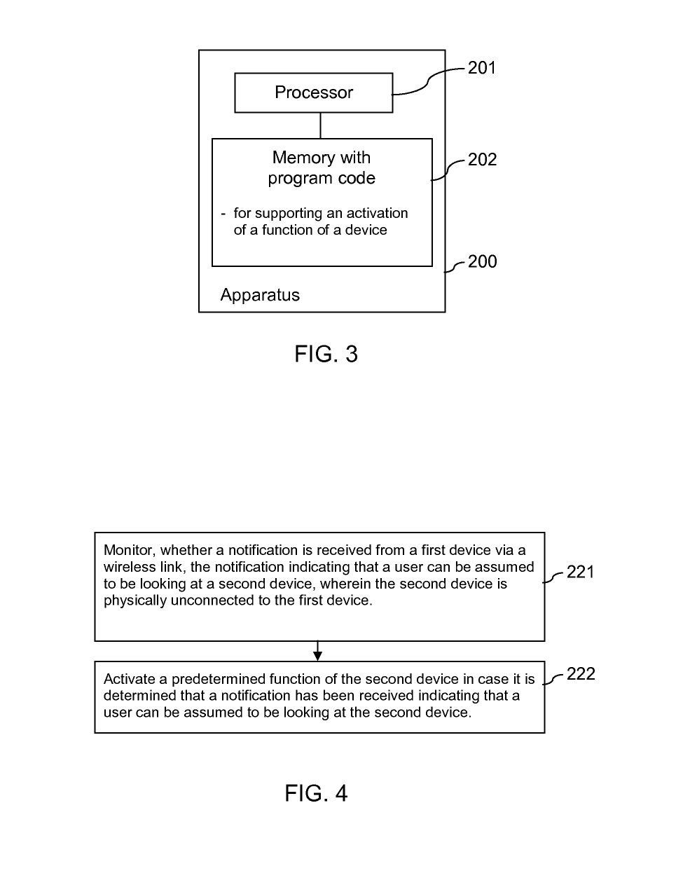

FIG. 3 is a schematic block diagram of an example embodiment of an apparatus according to the second aspect. Apparatus 200 comprises a processor 201 and, linked to processor 201, a memory 202. Memory 202 stores computer program code for supporting an activation of a function of a device. Processor 201 is configured to execute computer program code stored in memory 202 in order to cause an apparatus to perform desired actions. Memory 202 is thus an example embodiment of a non-transitory computer readable storage medium according to the second aspect, in which computer program code is stored.

Apparatus 200 could be a mobile device, like a mobile phone or a laptop, or a non-mobile stationary device, like a television (TV) set, a liquid crystal display (LCD) or any other type of display, or a personal computer (PC) with a separate display of any type. Apparatus 200 could equally be a component, like a chip, circuitry on a chip or a plug-in board, for any device. Optionally, apparatus 200 could comprise various other components, like a camera, a communication interface configured to enable an exchange of data with other apparatuses, a user interface, a further memory, a further processor, etc.

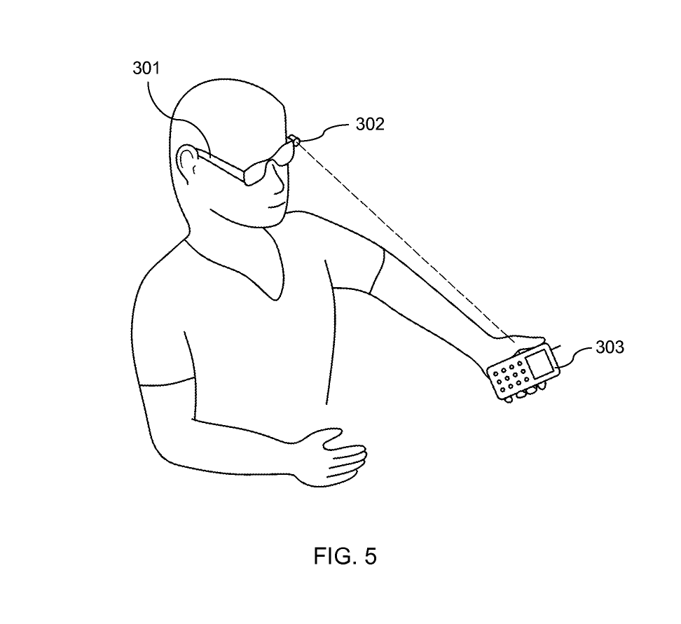

An operation of an apparatus will now be described with reference to the flow chart of FIG. 4. The operation is an example embodiment of a method according to the second aspect of the invention. Processor 201 and the program code stored in memory 202 cause an apparatus to perform the operation when the program code is retrieved from memory 202 and executed by processor 201. The apparatus that is caused to perform the operation can be apparatus 200 or some other apparatus, for example but not necessarily a device comprising apparatus 200. The apparatus monitors, whether a notification is received from a first device via a wireless link, the notification indicating that a user can be assumed to be looking at a second device, wherein the second device is physically unconnected to the first device. (action 221) Without limiting the scope of the claims, the first device could be or comprise or be linked to some apparatus causing a transmission of the notification, for example the apparatus of FIG. 1.

The apparatus furthermore activates a predetermined function of the second device in case it is determined that a notification has been received indicating that a user can be assumed to be looking at the second device. (action 222)

In many situations, a user may not benefit from a conventional automatic activation of a function of a device in response to a certain event. For example, a user may not need a presentation of information on the display of a mobile phone whenever there is an incoming call. This may be the case, for instance, if the phone has been left at another place or in case the user does not wish to be disturbed by any call. In this case, it may be a waste of battery power to activate the display. In other cases, it may be a waste of battery power to activate the display right away, because a user may first have to get the phone out of some bag or because a user decides to see who is calling only after the phone has been ringing for a longer time. In order to enable a saving of power in such cases, a device could use an integrated camera to detect when the user is looking at the device and turn the display on and off based on the result. Thus, the display could be kept bright just for as long as the user is looking at it.

Certain embodiments of the invention provide that a determination, whether a user can be assumed to be looking at a device as a basis for deciding on whether to activate a certain function of the device, can be outsourced from the device. The determination may be performed to this end by an apparatus that is not physically connected to the device based on data captured by at least one sensor. The sensor may be a part of the apparatus or otherwise linked to the apparatus. When the apparatus determines that a user can be assumed to be looking at the device, it may cause a transmission of a corresponding notification to another apparatus. The other apparatus may take care of activating the function of the device in response to the receipt of the notification. The other apparatus may be a part of the device or otherwise being linked to the device. The actual transmission of the notification may be performed by a device corresponding to the apparatus, comprising the apparatus or otherwise linked to the apparatus, that is not physically connected to the device of which a function is to be activated.

Without limiting the scope of the claims, certain embodiments thus provide an alternative to existing solutions using an integrated camera in a mobile phone for controlling the state of a display. Without limiting the scope of the claims, certain embodiments may have the effect that they can be used for controlling different kinds of functions. Without limiting the scope of the claims, certain embodiments may have the effect that they can be used for controlling the functions of devices of different kinds, not only of mobile phones. Without limiting the scope of the claims, certain embodiments may have the effect that a more accurate determination may be achieved of whether or not a user can be assumed to be looking at a device.

The apparatuses 100, 200 illustrated in FIGS. 1 and 3 and the methods illustrated in FIGS. 2 and 4 may be implemented and refined in various ways.

In the next passages, without limiting the scope of the claims, the apparatus according to the first aspect will be referred to as first apparatus. The device transmitting a notification will be referred to as first device. The apparatus according to the second aspect will be referred to as second apparatus. The device of which a function is to be controlled will be referred to as second device.

In an example embodiment, the first apparatus, the first device and the sensor are physically unconnected to the second apparatus and to the second device.

For the transmission, any direct or indirect wireless link may be used, for instance a Bluetooth link, a wireless local area network (WLAN) link or an infrared link complying with Infrared Data Association (IrDA) standard, etc.

The at least one sensor may comprise one or more sensors of various types.

In an example embodiment, the at least one sensor comprises an image sensor of a camera. The camera can be configured to capture still images and/or configured to capture video images. In an example embodiment, evaluating data captured by the at least one sensor may then comprise evaluating whether a stored image of at least a part of the second device can be matched to a part of an image captured by the camera. Without limiting the scope of the claims, detecting the second device in an image captured by the camera may be a hint that the user is looking at least roughly in the direction of the second device, if the camera is arranged to have the same viewing direction as the user.

Alternatively, evaluating data captured by at least one sensor may comprise evaluating whether a stored image of at least a part of the second device can be matched to a part of a predetermined area of an image captured by the camera. Without limiting the scope of the claims, this may have the effect that it may be determined whether the user can be assumed to be looking more or less directly at the second device, since it allows taking account of the viewing angle of the user. Further alternatively, evaluating data captured by at least one sensor may comprise evaluating whether it can be predicted that a stored image of at least a part of the second device can be matched to a part of a predetermined area of an image captured by the camera. This may be achieved, for instance by tracking the stored image over several captured images, to see whether the second device in the stored image moves into the direction of the predetermined area. Without limiting the scope of the claims, this may have the effect that it may be determined whether the user can be assumed to be looking more or less directly at the second device in the near future. As a result, in certain embodiments the function of the second device may be activated slightly earlier than without prediction, which may further improve the user experience.

It is to be understood that such a predetermined area could be set depending on the exact position that the camera has in relation to the eyes of the user if used as intended. In certain embodiments, a predetermined area could also be set individually for each user. For instance, the user could press a button when looking at the second device to capture an image. A stored image of the second device could then be matched to the area in the captured image showing the second device, and this area could be selected as the predetermined area. An image of at least a part of the second device will also be referred to as template.

In an example embodiment, evaluating data captured by the at least one sensor comprises evaluating whether a predetermined signal is provided by the second device. Without limiting the scope of the claims, such a signal could be a light signal of a predetermined wavelength or pattern. It is to be understood that this evaluation may be used in addition or alternatively to an evaluation of an image captured by a camera. If used in addition, without limiting the scope of the claims, the evaluation of the signal could provide a confirmation of the result of the evaluation of captured image data.

In an example embodiment, determining whether a user can be assumed to be looking at the second device by evaluating data captured by the at least one sensor comprises checking whether data captured by the at least one sensor meets a criterion. Without limiting the scope of the claims, the criterion could be that a stored image can be matched to a captured image. In case the data meets the criterion, the first apparatus may cause a transmission of a request to the second apparatus via a wireless link to cause a predetermined action. Without limiting the scope of the claims, the predetermined action could be the emission of a signal. The first apparatus may then determine that a user can be assumed to be looking at a device in case data captured by the at least one sensor confirms that the predetermined action has been registered by the at least one sensor. Without limiting the scope of the claims, this may have the effect that the first apparatus may differentiate between second devices of similar appearance.

In an example embodiment, a corresponding second apparatus may monitor whether a request to cause a predetermined action is received from the first device via a wireless link. In case it is determined that such a request is received, the second apparatus may cause the predetermined action. In certain embodiments, this monitoring may take place at the second apparatus as a preceding action, before monitoring whether a notification is received indicating that a user can be assumed to be looking at the second device.

In an example embodiment, the monitoring whether a notification is received is performed by the second apparatus, whenever a predefined event occurs or a predefined criterion is met. Without limiting the scope of the claims, such an event may comprise for example an incoming session at a mobile phone and the predefined criterion may comprise a low battery mode. Without limiting the scope of the claims, this may have the effect that processing power for the monitoring is saved when not needed. It is to be understood, however, that in certain embodiments, the second apparatus could also perform the monitoring continuously.

In an example embodiment, the predetermined function comprises turning on a display. It is to be understood, however, that any other function may be used as well. Another example functions could be unlocking keys of a device or permitting a start of certain communications with other devices.

In an example embodiment, the second device is configured to enable a user to specify at least one first device from which notifications are accepted. For instance, a pairing between the first device and the second device could be required. Without limiting the scope of the claims, this may be done by inputting to the second apparatus a unique identifier of the first apparatus, of the first device, of a component of the first apparatus or of a component of the first device. Such a component could be for instance a Bluetooth component or a WLAN component. Without limiting the scope of the claims, this may have the effect that the second apparatus may only act upon notifications received from the identified first device.

FIG. 5 is a diagram illustrating an example use case.

A user wears a pair of glasses 301. A camera 302 is integrated into the pair of glasses. The user further has a mobile phone 303. When mobile phone 303 is in a predefined state—like receiving an incoming call—the display of mobile phone 303 is turned on, in case images captured by camera 302 indicate that the user is looking at mobile phone 303 and a transmitter integrated into the glasses 301 transmits a corresponding notification via a wireless link to mobile phone 303.

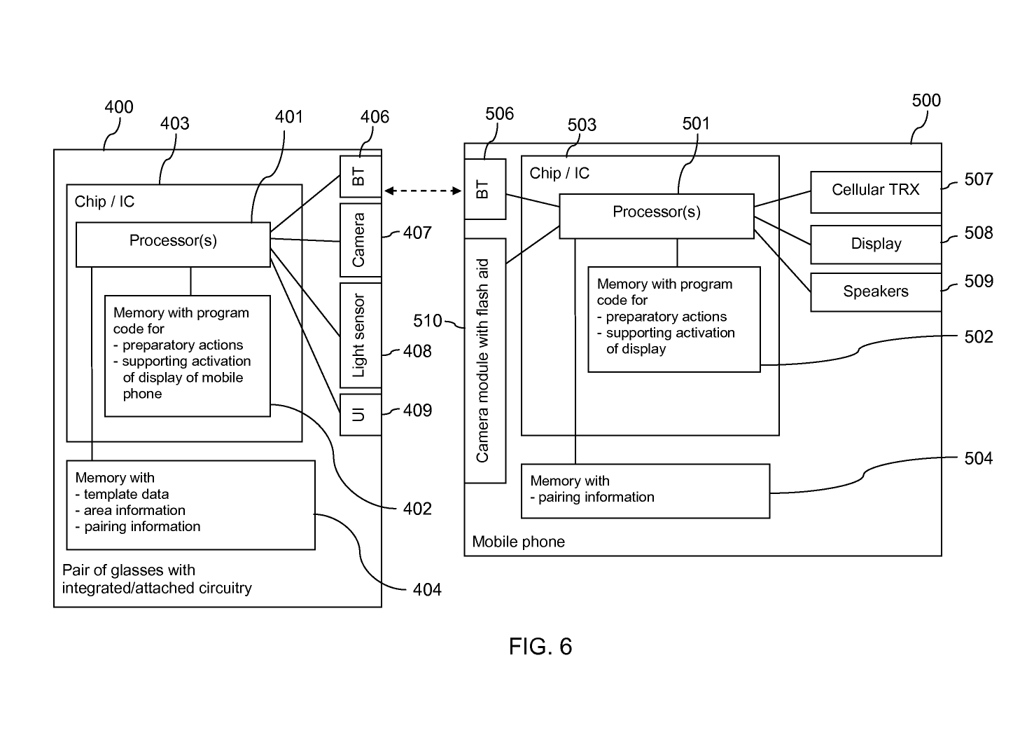

FIG. 6 is a schematic block diagram of an example embodiment of a system, which comprises a first device 400 and a second device 500 and in which a function of second device 500 can be activated by actions of first device 400.

By way of example, first device 400 is assumed to be a pair of glasses, but it could also be any other device that can be worn by a user in such a way that it will automatically change its orientation along with the head of the user.

By way of example, second device 500 is assumed to be a mobile phone, but it could also be any other device that supports activation of a function that may only be of interest when a user is looking at the device.

Glasses 400 comprise at least one processor 401 and, linked to processor 401, a first memory 402, a second memory 404, a Bluetooth module 406, a camera 407, a light sensor 408 and a user interface (UI) 409. All these components could be integrated for instance as a module or in a distributed manner into one of the temples of glasses 400. It is to be understood that in another embodiment, a module comprising these components could be attached for instance to one of the temples of the glasses.

Processor 401 is configured to execute computer program code, including computer program code stored in memory 402, in order to cause glasses 400 to perform desired actions. It is to be understood that processor 401 may comprise or be connected to an additional random access memory (not shown) as a working memory.

Memory 402 stores computer program code for supporting an activation of a function of another device, like device 500. The computer program code may comprise for example similar program code as memory 102. In addition, memory 402 may store computer program code implemented to realize other functions, for instance computer program code for preparatory actions like pairing glasses 400 with a particular other device or creating a template, determining an image area for the template, etc. Memory 402 could also store other kind of data than program code.

Processor 401 and memory 402 may optionally belong to a chip or an integrated circuit 403, which may comprise in addition various other components, for instance another memory or parts of Bluetooth module 406, camera 407 or sensor 408.

Memory 404 can equally be accessed by processor 401. It is configured to store template data, data defining a particular area of images captured by camera 407 and pairing information pairing glasses 400 to a particular other device. In addition, memory 404 could store other data.

It is to be understood that memory 402 and memory 404 could also be realized as a single memory.

Bluetooth module 406 enables a wireless transfer of data over a short distance in compliance with the Bluetooth standard. It may comprise for instance a transceiver and a control unit. The functions of the control unit could also be realized by processor 401 using a suitable program code stored in memory 402.

Camera 407 could be a photographic camera or a video camera. Camera 407 is or comprises an image sensor as an example first sensor.

Light sensor 408 could optionally be configured to detect light of a particular wavelength. Light sensor 408 is an example second sensor.

User interface 409 could comprise for instance one or more buttons or switches enabling a user to control a switching on and off of the other components and/or a creation of a template, etc. It could also comprise a small display or other output means like light emitting diodes (LEDs) indicating a current status of glasses 400, in particular, though not exclusively, for supporting preparatory actions.

Glasses 400 equally comprise a battery or an accumulator (not shown). The battery or accumulator is connected to all components of glasses 400 requiring a power supply.

Glasses 400 could comprise various other components, for instance components enabling a use of the camera for other purposes.

Component 403 or glasses 400 could correspond to example embodiments of an apparatus according to the first aspect of the invention.

Mobile phone 500 comprises at least one processor 501 and, linked to processor 501, a first memory 502, a second memory 504, a Bluetooth module 506, a cellular transceiver (TRX) 507, a display 508, speakers 509 and a camera module 510.

Processor 501 is configured to execute computer program code, including computer program code stored in memory 502, in order to cause mobile phone 500 to perform desired actions. It is to be understood that processor 501 may comprise or be connected to an additional random access memory (not shown) as a working memory.

Memory 502 stores computer program code for supporting an activation of at least one function of mobile phone 500, including a turning on of the display 508. The computer program code may comprise for example similar program code as memory 202. In addition, memory 502 may store computer program code implemented to realize other functions, for instance preparatory actions like pairing mobile phone 500 with a particular other device, handling cellular communications, etc., as well as any other kind of data.

Processor 501 and memory 502 may optionally belong to a chip or an integrated circuit 503, which may comprise in addition various other components, for instance another memory or parts of Bluetooth module 506 or camera module 510.

Memory 504 can equally be accessed by processor 501. It is configured to store pairing information pairing mobile phone 500 to a particular other device. In addition, memory 504 could store other data.

It is to be understood that memory 502 and memory 504 could also be realized as a single memory.

Bluetooth module 506 enables a wireless transfer of data over a short distance in compliance with the Bluetooth standard. It may comprise a transceiver and a control unit. The functions of the control unit could also be realized by processor 501 using a suitable program code stored in memory 502.

Cellular transceiver 507 could be a transceiver supporting any desired kind of mobile communication, for instance global system for mobile communications (GSM) based communications, universal mobile telecommunications system (UMTS) based communications, CDMA2000 based communications or long term evolution (LTE) based communications, etc. A corresponding cellular engine could be integrated into the transceiver 507, provided in addition, or be realized by processor 501 using additional suitable program code stored in memory 502.

Display 508 could be touch-sensitive or not.

Camera module 510 could comprise a camera and a flash aid, for example in the form of an LED. Such a camera LED could be included for instance as an autofocus (AF) assist lamp, for providing a pre-flash for through-the-lens (TTL) metering and/or for providing a flash.

Mobile phone 500 comprises in addition a battery or an accumulator (not shown). The battery or accumulator is connected to all components of mobile phone 500 requiring a power supply.

Mobile phone 500 could comprise various other components, for instance user input means. Component 503 or mobile phone 500 could correspond to example embodiments of an apparatus according to the second aspect of the invention.

It is to be understood that instead of Bluetooth modules 406, 506, devices 400 and 500 could comprise other communication modules enabling a direct or indirect wireless connection, for instance WLAN modules.

Glasses 400 and mobile phone 500 are assumed to belong to the same user, and the user may wish that in the case of incoming calls or other selected events or modes, the display 508 of mobile phone 500 is only turned on automatically, in case the user looks at mobile phone 500.

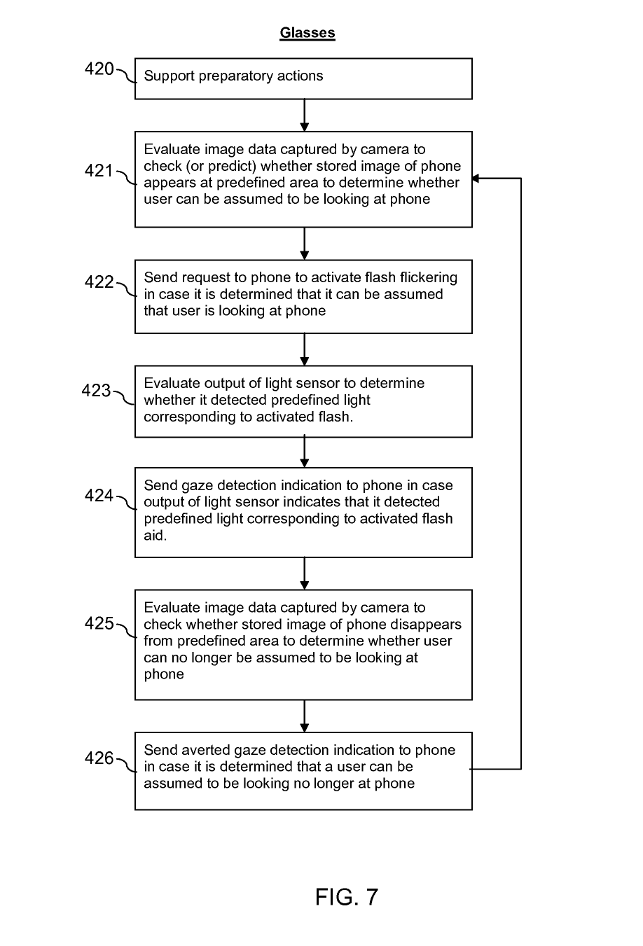

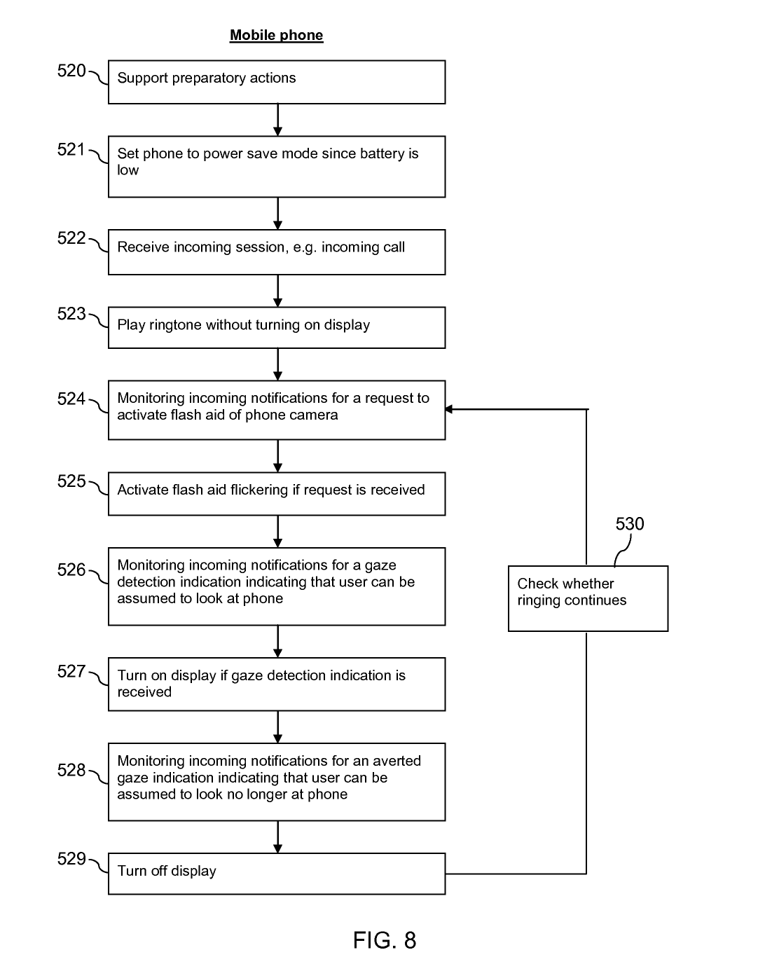

Example operations in the system of FIG. 6 will now be described with reference to FIGS. 7 and 8.

Example operations at glasses 400 of FIG. 6 will be described with reference to FIG. 7. Processor 401 and some of the program code stored in memory 402 cause glasses 400 to perform the presented operations when the program code is retrieved from memory 402 and executed by processor 401. Example operations at mobile phone 500 of FIG. 6 will be described with reference to FIG. 8. Processor 501 and some of the program code stored in memory 502 cause mobile phone 500 to perform the presented operations when the program code is retrieved from memory 502 and executed by processor 501.

The user of glasses 400 and mobile phone 500 may first take some preparatory actions supported by both devices 400, 500. (actions 420, 520)

The user may define in a configuration menu of mobile phone 500 in which circumstances display 508 of mobile phone 500 is to be turned on automatically only if the user can be assumed to be looking at mobile phone 500. For example, such circumstances may be selected to be given in the case of incoming calls and/or incoming messages or in the case of calendar alerts, etc. If the aim is mainly to safe battery power and less to increase the security, it may be defined in addition that the phone 500 has to be in a power save mode.

The user may further cause a pairing of glasses 400 and mobile phone 500. The pairing may involve an authentication of glasses 400, in order to ensure that a communication for the activation of a function of mobile phone 500—namely the turning on of display 508 in the present example—may only take place with selected devices. In this context, the user may be required to enter some identifier for the glasses 400 in mobile phone 500.

The user may furthermore cause a storage of an available template in memory 404. The template is an image of mobile phone 500. The template could be provided for example via mobile phone 500 and the Bluetooth connection based on a download from some server. Glasses 400 could also be configured to enable a user to generate the template with camera 407 using the user interface 409, though.

Using the user interface 409, the user may moreover cause glasses 400 to capture an image while wearing the glasses 400 and while looking directly at mobile phone 500, which is placed at a suitable distance for looking at display 508. Glasses 400 could then detect the template stored in memory 404 in the captured image and store an indication of the area of the image in which the template was found in memory 404.

After such example preparatory actions, glasses 400 may be used for supporting a turning on of display 508 of mobile phone 500.

To this end, camera 407 of glasses 400 captures photographic images at regular intervals or video images, whenever glasses 400 are powered on, or optionally only whenever the user selected in addition a monitoring mode. Data of captured images is provided to processor 401.

As illustrated in FIG. 7, processor 401 evaluates the data that is provided by camera 407 to check whether an image of mobile phone 500 represented by a template stored in memory 404 appears in a captured image. If the user is wearing glasses 400, this provides information on whether the user is looking in the general direction of mobile phone 500. (action 421) If memory 404 stores an indication of a predefined area, the checking may be limited to this area in the captured image. This may reduce the processing load at glasses 400 and provides information on whether the user is looking rather exactly in the direction of mobile phone 500. Alternatively, the entire captured image may be checked for a match, even if an indication of a predefined area is stored in memory 404. If the image of mobile phone 500 appears in the captured image, the movement of mobile phone 500 may be tracked in a sequence of images captured by camera 407. If it moves in direction of the predefined area, it can be predicted that the user is about to look at mobile phone 500. This may then be considered an (in advance) assumption that the user is looking at mobile phone 500.

If it is determined that the user can be assumed to be looking at mobile phone 500, processor 401 causes Bluetooth module 406 to transmit a request to activate a flash flickering to mobile phone 500. (action 422)

Thereupon, processor 401 evaluates an output of light sensor 408, in order to determine whether a predefined light corresponding to a flickering flash aid is detected. (action 423) Sensor 408 could detect only light having a particular wavelength and the evaluation could consider in addition whether the pattern of any detected light corresponds to a predetermined pattern. It is to be understood that optionally, light sensor 408 may be activated by processor 401 for a predetermined maximum period of time after the request has been transmitted. In case no flickering flash aid is detected during a predetermined maximum period of time, the operation could continue with action 421.

When a flickering flash aid is detected, this confirms that the user is looking in the direction of phone 500. In particular, it confirms that the user is not looking in the direction of another, similar looking phone instead. In this case, processor 401 causes a transmission of a gaze detection indication to phone 500 via Bluetooth module 406. (action 424)

In parallel or thereafter, processor 401 may continue evaluating data from camera 407 to check whether the image of phone 500 represented by the template stored in memory 404 disappears again from the predefined area of images captured by camera 407. If this is the case, it may be assumed that the user is no longer looking at phone 500. (action 425)

If it is determined that it can be assumed that the user is no longer looking at phone 500, processor 401 causes a transmission of an averted gaze detection indication to phone 500 via Bluetooth module 406. (action 426)

Thereafter, the operation may continue with the monitoring of action 421.

Turning now to FIG. 8 again, mobile phone 500 sets itself at some time to a power save mode, since the charge of battery is low. (action 521)

In this state, mobile phone 500 receives an incoming session, for example an incoming call, via cellular transceiver 507. (action 522)

Mobile phone 500 plays a ringtone using speakers 509. Due to the power save mode, however, it does not turn on the display 508 right away. (action 523)

Instead, mobile phone 500 monitors whether there is any incoming request from a paired device via Bluetooth module 506 to activate the camera flash aid. (action 524)

The transmission of such a request by glasses 400 as an example paired device was described further above as action 422.

If such a request is received mobile phone 500, a flash aid flickering by camera module 510 is activated. (action 525)

Thereupon, mobile phone 500 monitors whether a gaze detection indication is received from the paired device via Bluetooth module 506. Such a gaze detection indication is a notification indicating that the user can be assumed to be looking at mobile phone 500. (action 526)

The transmission of such a gaze detection indication by glasses 400 as an example paired device was described further above as action 424.

If receipt of a gaze detection indication is detected, mobile phone 500 turns on display 508, which may present information on the incoming call. (action 527)

In case action 421 described above includes a tracking of the image of mobile phone 500 in images captured by camera 407 and a prediction of whether the user will be looking at mobile phone 500, display 508 may be turned on in certain embodiments without delay or even slightly before the user actually looks at mobile phone 500, because actions 422, 423, 424, 525, 526 and 527 may be triggered somewhat earlier than without prediction.

Now, mobile phone 500 may monitor whether any averted gaze indication is received via Bluetooth module 506 from the paired device. Such an averted gaze indication is a notification indicating that the user can be assumed not to be looking at mobile phone 500 anymore. (action 528)

The transmission of such an averted gaze indication by glasses 400 as an example paired device was described further above as action 426.

If receipt of an averted gaze indication is detected, mobile phone 500 turns display 508 off again. (action 529)

As long as the phone keeps ringing (action 530), mobile phone 500 may continue to monitor whether the user is looking at mobile phone 500 again, and if so, turn on display 508 again.

Thus, mobile phone 500 may be configured such that display 508 is turned on automatically in certain situations if the user is looking at it. On the one hand, this may save battery power, in particular when the battery of mobile phone 500 is already low. On the one hand, this may increase security, because it may prevent other persons to inconspicuously read the information on display 508 while the user is looking into another direction. Based on the data provided by camera 407, the stored template and the predefined area, the viewing angle of the user relative to mobile phone 500 can be determined quite precisely.

It is to be understood that the operations presented in FIGS. 7 and 8 could be modified in many ways and that the order of actions could be changed.

For example, it would be possible to omit the additional activation and detection of a flash aid flickering. That is, the display could be caused to be switched on right away when the image represented by a template is found in a captured image or in a particular area of a captured image. Furthermore, it would be possible to use glasses 400 only for controlling the turning on of display 508 and not for a turning off of display 508. Furthermore, it would be possible to have glasses 400 control the turning on of display 508 regardless of the current battery state and any associated power mode of mobile phone 500.

It is further to be understood that in other example embodiments, a similar approach may be used for activating other functions of a mobile phone, for activating functions of a mobile phone in the case of other conditions, and for activating similar or other functions of other kinds of devices, in each case using glasses or some other suitable device.

For example, the display of a TV set may be turned on automatically when a user is assumed to be looking at the TV set, for instance, in case the TV set has been set to a specific mode for automatically turning on the display. Additional criteria may be defined, like particular times of the day or the start of a selected program, etc.

A single pair of glasses may also be used for activating functions of several devices of the user. Functions of some devices that are used by several users, like TV sets, may be allowed to be activated using several pairs of glasses or other devices.

Any presented connection in the described embodiments is to be understood in a way that the involved components are operationally coupled. Thus, the connections can be direct or indirect with any number or combination of intervening elements, and there may be merely a functional relationship between the components.

Further, as used in this text, the term ‘circuitry’ refers to any of the following:

(a) hardware-only circuit implementations (such as implementations in only analog and/or digital circuitry)

(b) combinations of circuits and software (and/or firmware), such as: (i) to a combination of processor(s) or (ii) to portions of processor(s)/ software (including digital signal processor(s)), software, and memory(ies) that work together to cause an apparatus, such as a mobile phone, to perform various functions) and

(c) to circuits, such as a microprocessor(s) or a portion of a microprocessor(s), that require software or firmware for operation, even if the software or firmware is not physically present.

This definition of ‘circuitry’ applies to all uses of this term in this text, including in any claims. As a further example, as used in this text, the term ‘circuitry’ also covers an implementation of merely a processor (or multiple processors) or portion of a processor and its (or their) accompanying software and/or firmware. The term ‘circuitry’ also covers, for example, a baseband integrated circuit or applications processor integrated circuit for a mobile phone.

Any of the processors mentioned in this text could be a processor of any suitable type. Any processor may comprise but is not limited to one or more microprocessors, one or more processor(s) with accompanying digital signal processor(s), one or more processor(s) without accompanying digital signal processor(s), one or more special-purpose computer chips, one or more field-programmable gate arrays (FPGAS), one or more controllers, one or more application-specific integrated circuits (ASICS), or one or more computer(s). The relevant structure/hardware has been programmed in such a way to carry out the described function. Any of the memories mentioned in this text could be implemented as a single memory or as a combination of a plurality of distinct memories, and may comprise for example a read-only memory (ROM), a random access memory (RAM), a flash memory or a hard disc drive memory etc.

Moreover, any of the actions described or illustrated herein may be implemented using executable instructions in a general-purpose or special-purpose processor and stored on a computer-readable storage medium (e.g., disk, memory, or the like) to be executed by such a processor. References to ‘computer-readable storage medium’ should be understood to encompass specialized circuits such as FPGAs, ASICs, signal processing devices, and other devices.

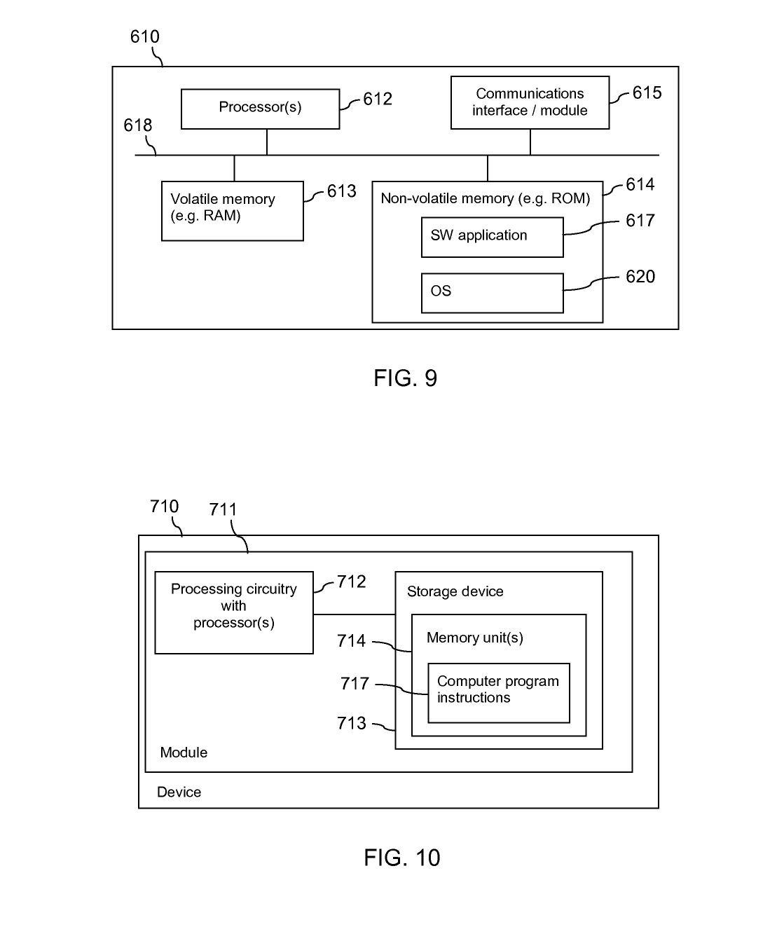

Example embodiments using at least one processor and at least one memory as a non-transitory data medium are shown in FIGS. 9 and 10.

FIG. 9 is a schematic block diagram of a device 610. Device 610 includes a processor 612. Processor 612 is connected to a volatile memory 613, such as a RAM, by a bus 618. Bus 618 also connects processor 612 and RAM 613 to a non-volatile memory 614, such as a ROM. A communications interface or module 615 is coupled to bus 618, and thus also to processor 612 and memories 613, 614. Within ROM 614 is stored a software (SW) application 617. Software application 617 may be a navigation application, although it may take some other form as well. An operating system (OS) 620 also is stored in ROM 614.

FIG. 10 is a schematic block diagram of a device 710. Device 710 may take any suitable form. Generally speaking, device 710 may comprise processing circuitry 712, including one or more processors, and a storage device 713 comprising a single memory unit or a plurality of memory units 714. Storage device 713 may store computer program instructions that, when loaded into processing circuitry 712, control the operation of device 710. Generally speaking, also a module 711 of device 710 may comprise processing circuitry 712, including one or more processors, and storage device 713 comprising a single memory unit or a plurality of memory units 714. Storage device 713 may store computer program instructions that, when loaded into processing circuitry 712, control the operation of module 711.

The software application 617 of FIG. 9 and the computer program instructions 717 of FIG. 10, respectively, may correspond e.g. to the computer program code in memory 102, memory 202, memory 402 or memory 502.

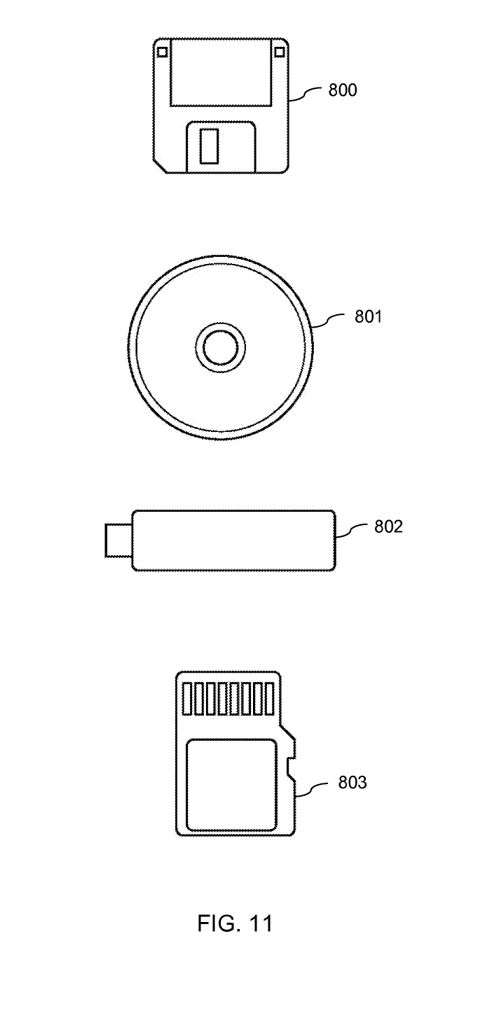

In example embodiments, any non-transitory computer readable medium mentioned in this text could also be a removable/portable storage or a part of a removable/portable storage instead of an integrated storage. Example embodiments of such a removable storage are illustrated in FIG. 11, which presents, from top to bottom, schematic diagrams of a magnetic disc storage 800, of an optical disc storage 801, of a semiconductor memory circuit device storage 802 and of a Micro-SD semiconductor memory card storage 803.

The functions illustrated by processor 101 in combination with memory 102, by processor 401 in combination with memory 402, or by integrated circuit 403 can also be viewed as means of an apparatus for determining, whether a user can be assumed to be looking at a device by evaluating data captured by at least one sensor, wherein the apparatus is physically unconnected to the device; and as means of the apparatus for causing a transmission of a notification to a second apparatus via a wireless link, in case it is determined that a user can be assumed to be looking at the device, as a criterion for the second apparatus to activate a function of the device.

The program codes in memories 102 and 402 can also be viewed as comprising such means in the form of functional modules.

The functions illustrated by processor 201 in combination with memory 202, by processor 501 in combination with memory 502 or by integrated circuit 503 can also be viewed as means of an apparatus for monitoring whether a notification is received from a first device via a wireless link, the notification indicating that a user can be assumed to be looking at a second device, wherein the second device is physically unconnected to the first device; and as means of the apparatus for activating a predetermined function of the second device in case it is determined that a notification has been received indicating that a user can be assumed to be looking at the second device.

The program codes in memories 202 and 502 can also be viewed as comprising such means in the form of functional modules.

FIGS. 2, 4, 7 and 8 may also be understood to represent example functional blocks of computer program codes supporting an activation of a function of a device.

The rectangles in FIGS. 2, 4, 7 and 8 may also be understood to represent components of apparatuses supporting an activation of a function of a device in the form of a block diagram.

It will be understood that all presented embodiments are only examples, and that any feature presented for a particular example embodiment may be used with any aspect of the invention on its own or in combination with any feature presented for the same or another particular example embodiment and/or in combination with any other feature not mentioned. It will further be understood that any feature presented for an example embodiment in a particular category may also be used in a corresponding manner in an example embodiment of any other category.

1. A method comprising:
determining, by a first apparatus, whether a user can be assumed to be looking at a second device by evaluating data captured by at least one sensor, wherein the first apparatus is physically unconnected to the second device; and
causing, by the first apparatus, a transmission of a notification to a second apparatus via a wireless link, in case it is determined that a user can be assumed to be looking at the second device, as a criterion for the second apparatus to activate a function of the device.

2. The method according to claim 1, wherein the at least one sensor comprises an image sensor of a camera and wherein evaluating data captured by the at least one sensor comprises one of
evaluating whether a stored image of at least a part of the second device can be matched to a part of an image captured by the camera;
evaluating whether a stored image of at least a part of the second device can be matched to a part of a predetermined area of an image captured by the camera; and
evaluating whether it can be predicted that a stored image of at least a part of the second device can be matched to a part of a predetermined area of an image captured by the camera.

3. The method according to claim 1, wherein evaluating data captured by the at least one sensor comprises evaluating whether a predetermined signal is provided by the second device.

4. The method according to claim 1, wherein determining whether a user can be assumed to be looking at the second device by evaluating data captured by the at least one sensor comprises:
checking whether data captured by the at least one sensor meets a criterion;
in case the data meets the criterion, causing a transmission of a request to the second apparatus via a wireless link to cause a predetermined action; and
determining that a user can be assumed to be looking at a second device in case data captured by the at least one sensor confirms that the predetermined action has been registered by the at least one sensor.

5. A method comprising:
monitoring, by a second apparatus, whether a notification is received from a first device via a wireless link, the notification indicating that a user can be assumed to be looking at a second device, wherein the second device is physically unconnected to the first device; and
activating, by the second apparatus, a predetermined function of the second device in case it is determined that a notification has been received indicating that a user can be assumed to be looking at the second device.

6. The method according to claim 5, wherein the monitoring is performed only, whenever a predefined event occurs or a predefined criterion is met.

7. The method according to claim 5, further comprising as a preceding action
monitoring whether a request to cause a predetermined action is received from the first device via a wireless link; and
in case it is determined that such a request is received, causing the predetermined action.

8. The method according to claim 5, wherein the predetermined function comprises turning on a display.

9. The method according to claim 5, wherein the second device is configured to enable a user to specify at least one first device from which notifications are accepted.

10.-13. (canceled)

14. A first apparatus comprising at least one processor and at least one memory including computer program code, the at least one memory and the computer program code configured to, with the at least one processor, cause the first apparatus to perform:
determine whether a user can be assumed to be looking at a second device by evaluating data captured by at least one sensor, wherein the first apparatus is physically unconnected to the second device; and
transmit a notification to a second apparatus via a wireless link, in case it is determined that a user can be assumed to be looking at the second device, as a criterion for the second apparatus to activate a function of the device.

15. The first apparatus according to claim 14, wherein the at least one sensor comprises an image sensor of a camera and wherein evaluating data captured by the at least one sensor comprises one of
evaluating whether a stored image of at least a part of the second device can be matched to a part of an image captured by the camera;
evaluating whether a stored image of at least a part of the second device can be matched to a part of a predetermined area of an image captured by the camera; and
evaluating whether it can be predicted that a stored image of at least a part of the second device can be matched to a part of a predetermined area of an image captured by the camera.

16. The first apparatus according to claim 14, wherein evaluating data captured by the at least one sensor comprises evaluating whether a predetermined signal is provided by the second device.

17. The first apparatus according to claim 14, wherein determining whether a user can be assumed to be looking at the second device by evaluating data captured by the at least one sensor comprises:
checking whether data captured by the at least one sensor meets a criterion;
in case the data meets the criterion, causing a transmission of a request to the second apparatus via a wireless link to cause a predetermined action; and
determining that a user can be assumed to be looking at a second device in case data captured by the at least one sensor confirms that the predetermined action has been registered by the at least one sensor.

18. (canceled)

19. The first apparatus according to claim 14, wherein the first apparatus is one of:
a device;
a chip configured to be used in a device;
a pair of glasses;
a cap;
a module configured to be integrated into a pair of glasses;
a module configured to be attached to a pair of glasses;
a module configured to be integrated into a cap; and
a module configured to be attached to a cap.

20. A second apparatus comprising at least one processor and at least one memory including computer program code, the at least one memory and the computer program code configured to, with the at least one processor, cause the second apparatus to perform:
monitor whether a notification is received from a first device via a wireless link, the notification indicating that a user can be assumed to be looking at a second device, wherein the second device is physically unconnected to the first device; and
activate a predetermined function of the second device in case it is determined that a notification has been received indicating that a user can be assumed to be looking at the second device.

21. The second apparatus according to claim 20, wherein the computer program code is configured to, with the at least one processor, cause the at second apparatus to perform the monitoring only, whenever a predefined event occurs or a predefined criterion is met.

22. The second apparatus according to claim 20, wherein the computer program code is configured to, with the at least one processor, cause the second apparatus to
monitor as a preceding action whether a request to cause a predetermined action is received from the first device via a wireless link; and
in case it is determined that such a request is received, cause the predetermined action.

23. The second apparatus according to claim 20, wherein the predetermined function comprises turning on a display.

24. The second apparatus according to one-of claim 20, wherein the computer program code is configured to, with the at least one processor, cause the second apparatus to enable a user to specify at least one first device from which notifications are accepted.

25. The second apparatus according to claim 20, wherein the second apparatus is one of:
a device;
a module configured to be used in a device;
a chip configured to be used in a device;
a mobile phone;
a television set;
a display; and
a laptop.

26.-29. (canceled)
